(19) United States
(12) Patent Application Publication
(10) Pub. No.: US 2025/0384249 A1
(43) Pub. Date: Dec. 18, 2025

(54) GENERATIVE ARTIFICIAL INTELLIGENCE MODEL SAFETY

(71) Applicant: Trustwise Inc., Austin, TX (US)

(72) Inventors: Manoj SAXENA, Austin, TX (US); Matthew BARKER, Edenbridge (GB); Avinash SAXENA, Katy, TX (US); Evan THOMAS, Durham (GB); James CARR, Northumberland (GB)

(21) Appl. No.: 18/936,895

(22) Filed: Nov. 4, 2024

Related U.S. Application Data
(60) Provisional application No. 63/661,519, filed on Jun. 18, 2024.

(51) Int. Cl. G06N 3/0475; G06F 21/62

(52) U.S. Cl. CPC G06N 3/0475; G06F 21/6245

(57) ABSTRACT

A method may include providing a query and context associated with the query to a generative artificial intelligence (Gen AI) model, the Gen AI model trained to generate a response to the query based on the context. The method may further include performing analysis of the Gen AI model based on a first relevancy between the query and the context, a second relevancy between the query and the response, and a third relevancy between the response and the context and refining the response based on the analysis.

### CROSS-REFERENCE TO RELATED APPLICATIONS

This patent application claims priority to U.S. Provisional Application No. 63/661,519 filed Jun. 18, 2024, which provisional is incorporated herein by specific reference in its entirety.

### BACKGROUND

### Field

The present invention relates to improving safety of generative artificial intelligence (AI) models.

### Description of the Related Art

As the value and use of data continues to increase, individuals and businesses seek additional ways to process and store information. One approach to data processing includes the use of generative AI systems such as a large language model (LLM). Such models may allow entities to access the data in a convenient and timely manner. For example, the LLM may be configured to take an input from a user and produce an output corresponding to the input based on the data available to the LLM. The user may obtain the output corresponding to the input without the need to go through the data manually. As use of generative AI systems increase, reliance of the users on the systems may also increase. To help the generative AI systems provide accurate outputs, the generative AI systems may be aligned with human values and/or various standards. For example, the generative AI systems may be aligned to global, national (e.g., U.S. National Institute of Standards and Technology (NIST) AI Risk Management Framework (AI RMF), EU AI Act, etc.), and/or industry policies (e.g., Financial Conduct Authority (FCA) Consumer Duty).

### SUMMARY OF THE INVENTION

According to an aspect of an embodiment, a method may include providing a query and context associated with the query to a generative artificial intelligence (Gen AI) model, the Gen AI model trained to generate a response to the query based on the context. The method may further include performing analysis of the Gen AI model based on a first relevancy between the query and the context, a second relevancy between the query and the response, and a third relevancy between the response and the context and refining the response based on the analysis.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example AI optimizing system, in accordance with one or more embodiments of the present disclosure;

FIG. 2 shows a flow diagram of an AI model safety process, in accordance with one or more embodiments of the present disclosure;

FIG. 3 is a flow chart of an example method of AI model safety process, in accordance with one or more embodiments of the present disclosure; and

FIG. 4 illustrates a block diagram of an example computing system that may be used with the optimizer system, in accordance with one or more embodiments of the present disclosure.

### DETAILED DESCRIPTION

Generative artificial intelligence (Gen AI) systems and/or models such as a large language model (LLM) may be configured and/or trained to generate responses to questions and/or queries based on contextual data available to the Gen AI models. For example, the Gen AI models may be trained to identify patterns in the contextual data to generate answers to the queries. Such process may allow convenient access to the contextual data without manual digestion of the contextual data. In some circumstances, the Gen AI systems may produce responses which may not be adequately formatted and/or assured. For example, the Gen AI systems may produce unsafe responses or responses that may include inaccuracy, bias, disrespectfulness, privacy violations, ambiguity, irrelevance, or other issues. Such issues may decrease confidence and/or trust in the Gen AI systems by users using the systems. In some circumstances, one or more operations may be performed such that instances of such unsafe responses may be reduced.

Gen AI assurance may include practices and/or processes that may help Gen AI systems to improve providing response that are more reliable, safe, ethical, and aligned with human values and regulatory requirements. Some traditional Gen AI assurance practices may include modifying and/or filtering training data; monitoring and moderating responses; implementing feedback loops where users report unsafe responses; providing ethical guidelines in AI development; and/or including human oversight where human operators review the response.

However, implementing such practices may not be cost effective and/or not feasible in larger scale. For example, building a new Gen AI system from scratch and/or customizing an existing Gen AI system for a specific entity or purpose may be highly costly. Additionally, requiring human oversight for every response may add additional time and cost to the operation of the Gen AI systems. As such, the assurance practices may be best implemented by large Gen AI developers that build the Gen AI systems. However, the large Gen AI developers generally do not have an incentive to perform assurance practices that adhere to specific entities and/or users. For example, large-scale LLM (e.g., a type of Gen AI system) builders may not have a reason or may not be adaptable to implement specific assurance practices for different users. Such large-scale LLM builders may focus on adhering to high-level standards and/or regulations without providing specific practices.

Another approach to improve LLMs may include retrieval-augmented generation (RAG). RAG may include a method used to improve the quality of generated text by incorporating information retrieved from external sources. For example, RAG may incorporate the domain-specific knowledge into the LLM, which may allow the LLM to more successfully answer questions related to such domain-specific knowledge. However, mere RAG operations without further guidance may lead to further problems. For example, RAG aims to better the quality of responses by only parsing the most relevant context chunks from the document into the LLM. However, when a query is unrelated to the document, a typical RAG pipeline may still retrieve what it measures as the most relevant context from the documents which may lead to confident responses containing non-factual, misleading information, or hallucinations.

The RAG may result in responses containing information from both the provided documents and the internal knowledge of the LLM, which may lead to extrinsic hallucinations (e.g., information that cannot be verified from the provided context) or self-contradictions (as the information in the provided context may differ from the internal knowledge).

According to one or more embodiments of the present disclosure, an AI optimizing system may be configured to perform one or more assurance operations such that the Gen AI systems may be improved. In particular, as described in detail in the present disclosure, the AI optimizing system may be configured to improve alignment of the Gen AI systems. In particular, existing Gen AI models may be tested based on user-specific policies and/or standards to identify Gen AI models that are best-suited for the user and to further improve the Gen AI models and/or responses generated using the Gen AI models to adhere to the user-specific policies.

Embodiments of the present disclosure will be exampled with reference to the accompanying drawings.

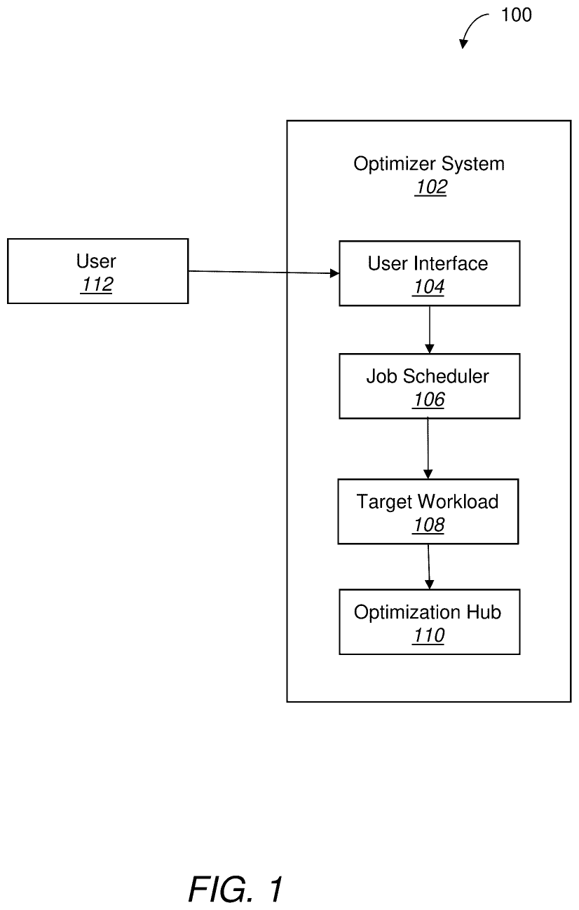

FIG. 1 illustrates an example Gen AI optimizing environment 100, in accordance with one or more embodiments of the present disclosure. In some embodiments, the environment 100 may include an optimizer system 102. In some embodiments, the optimizer system 102 may include a user interface 104, a job scheduler 106, a target workload 108, and/or an optimization hub 110.

In some embodiments, the user interface 104 may include any device and/or system that may allow a user 112 to communicate with the optimizer system 102. For example, the user interface 104 may include a platform in which the user 112 may interact with AI models, monitor performances, and/or provide feedback. The user interface 104 may be formatted in any suitable way to provide the platform to the user 112. For example, the platform may be provided as an application, a web application, among others. In some embodiments, the user 112 may provide, via the user interface 104, AI optimization configurations to be run. For example, the user 112 may specify types of AI optimization operations to be performed by the optimizer system 102.

In some embodiments, the job scheduler 106 may be configured to manage and/or automate the execution of tasks and/or jobs at specified times and/or under certain conditions. For example, the job scheduler 106 may be configured to schedule different AI optimization jobs, such as optimizing alignment, safety, and/or performance of AI models. The job scheduler 106 may determine which AI optimization jobs to be performed and in which order to perform the AI optimization jobs based on the AI optimization configuration provided by the user 112.

In some embodiments, the job scheduler 106 may send the scheduled jobs and/or operations to access the target workload 108. In some embodiments, the target workload 108 may include different Gen AI systems and/or models that may be optimized and/or other user 112 specified data such as context.

In some embodiments, the target workload 108 and the AI optimization configurations may be provided to the optimization hub 110. In some embodiments, the optimization hub 110 may be configured to run and deploy the AI optimization jobs such as optimizing alignment, safety, and/or performance. For example, the optimization hub 110 may include one or more modules and/or systems that may observe, analyze, and/or optimize the AI systems.

Modifications, additions, or omissions may be made to the environment 100 without departing from the scope of the present disclosure. For example, in some embodiments, the environment 100 may include any number of other components that may not be explicitly illustrated or described. Further, depending on certain implementations, the environment 100 may not include one or more of the components illustrated and described.

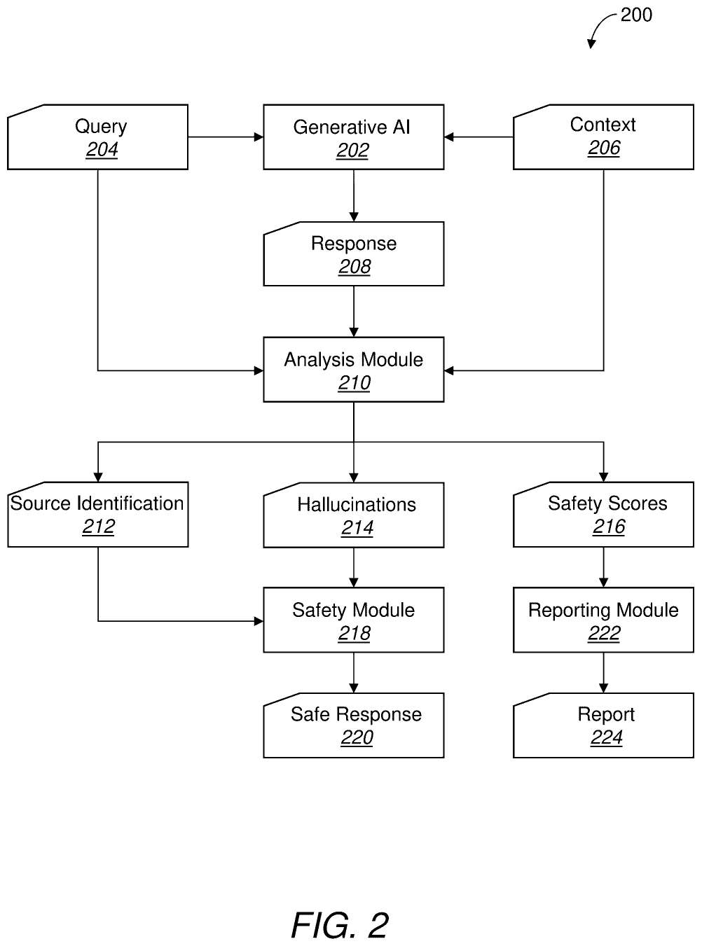

FIG. 2 illustrates an example system 200 configured to perform safety optimization of a Gen AI model 202, in accordance with one or more embodiments of the present disclosure. In some embodiments, the system 200 may include an analysis module 210, a safety module 218, and a reporting module 222. In some embodiments, the Gen AI model 202 may include any suitable Gen AI models such as an LLM that may generate a response to a query based on the contextual data. While a single Gen AI model 202 is illustrated, multiple Gen AI models or LLMs may be run through the system 200 concurrently and/or in parallel. For example, the Gen AI model 202 may represent one or more Gen AI models.

In some embodiments, the Gen AI model 202 may be trained to generate outputs or answers based on patterns learned from training data used to train the Gen AI model 202. For example, the Gen AI model 202 may generate a response 208 in response to a query 204. The query 204 may include a prompt, a question, and/or other instructions for the Gen AI model 202. In some embodiments, the Gen AI model 202 may generate the response 208 based on context 206 provided to the Gen AI model 202. For example, the Gen AI model 202 may generate the response 208 by applying the learned patterns to the context 206. In these and other embodiments, the context 206 may include background information relevant to the query 204 provided to the Gen AI model 202 by a user. For example, the context 206 may provide a database which the Gen AI model 202 may use to generate answers and/or outputs. In the present disclosure, the context 206 may refer to the contextual or background data that the Gen AI model 202 uses to generate the response 208.

In some embodiments, the analysis module 210 may be configured to analyze the Gen AI model 202 based on the response 208. For example, in some embodiments, the analysis module 210 may detect and/or diagnose hallucinations 214 present in the response 208. In these and other embodiments, hallucinations may refer to instances in which the Gen AI model 202 generates the response 208 including information that is factually incorrect, nonsensical, and/or fabricated but presented in a manner that appears plausible and/or convincing. Such hallucinations 214 may occur due to the Gen AI model 202 producing the response 208 based on patterns learned from training data rather than an understanding of factual correctness. Such occurrences may reduce the reliability of the Gen AI model 202.

In some embodiments, the analysis module 210 may be configured to identify sources and/or causes of the hallucinations 214. For example, the analysis module 210 may analyze the context 206, the query 204, and the response 208 to identify sources of hallucinations 214. Particularly, the analysis module 210 may be configured to investigate interplay between each pair of the query 204 and the context 206; the query 204 and the response 208; and the context 206 and the response 208.

In some embodiments, the investigation between the query 204 and the context 206 may be performed based on a relevancy metric (e.g., context relevancy). The relevancy metric may be configured to measure whether the context 206 contains all information relevant to answer the query 204. For example, in instances in which the context 206 does not include all relevant information needed to answer the query 204, the likelihood of instances of hallucinations 214 may increase. Such increased chance of hallucinations 214 may negatively affect the trust in the ability of the Gen AI model 202 to construct a relevant response 208. In instances in which the relevant information to the query 204 is contained within the context 206, the Gen AI model 202 may have an increased chance of generating a relevant response 208. In these and other embodiments, the Gen AI model 202 may handle a certain amount of irrelevant information in the context 206 in generating the relevant response 208. As the amount of irrelevant information in the context 206 increases, the ability of the Gen AI model 202 to generate the relevant response 208 may decrease.

In some embodiments, the context relevancy may involve assessing whether the context 206 contains all the information relevant to answer the query 204. First, the key topics discussed in the query 204 are identified. Each topic is compared to the context 206, and based on whether the topic is discussed in the context 206, a score is given to each topic representing how relevant each topic is to the context 206. In these and other embodiments, an overall context relevancy score may be then calculated, representing similarity between the query 204 and the context 206 as a whole. In some embodiments, the context relevancy score may be represented as a number within a range. For example, the context relevancy score may be represented as a number between 0 and 100, with a higher score meaning the context 206 is more relevant to the query 204. In these and other embodiments, as the context relevancy does not involve the response 208, while a low context relevancy (e.g., low context relevancy score) may imply the hallucination 214, the hallucination 214 does not necessarily imply a low context relevancy.

For example, a search for the definition of ‘hallucination’ in a dictionary may be done. In such an example, the query 204 may be ‘What is a hallucination?’ and the context 206 may be the contents of the dictionary. A suitable response 208 (e.g., the definition of hallucination) may still be obtained despite all the other words (e.g., irrelevant information). Only looking at words starting with ‘h’ in the dictionary (e.g., reducing the context chunk size) may speed up the finding process, but may not lead to a lower-quality response 208. A low context relevancy, however, such as, in this example, looking at only ‘g’ words in the dictionary, would more likely result in a lower quality response.

In some embodiments, the analysis of the relevancy between the query 204 and the response 208 may represent answer relevancy. In some embodiments, the answer relevancy may be analyzed based on an answer relevancy metric configured to analyze whether the response 208 is succinct, free from superfluous information and answering the query 204. For example, in instances in which the response 208 is substantially irrelevant to the query 204, the likelihood of the presence of hallucinations 214 may increase. The answer relevancy metric may not account for whether the response 208 is correct, as it is unable to do so without the provided context 206. The answer relevancy metric may simply address the relevance of the response 208 to the query 204. As such, a low answer relevancy may imply a hallucination 214, and a hallucination 214 does not necessarily imply a low answer relevancy.

For example, the query 204 may state ‘What is the day of the week today?’, and the response 208 may be given as ‘The current month of the year is March’. This may be indicative of the hallucination 214 as the response 208 is irrelevant to the query 204, so a low answer relevancy score may be seen. In another instance, the response 208 may recite ‘The day of the week today is Tuesday’. Such response 208 may now be relevant to the query 204 and may receive a high answer relevancy score, whether the actual day of the week was Tuesday or not, as such may be unknown without the context 206.

In some embodiments, the answer relevancy in evaluating the query 204 and the response 208 may involve determining whether the response 208 includes an attempt to answer the query 204, while being free from superfluous information. A query or set of queries is generated, using an AI model, for which response 208 would be a suitable answer. In some embodiments, the query may be reworded to match the style and/or tone of the generated query 204 or the set of queries. The query 204 and the generated query or the set of queries may be compared, resulting in an answer relevancy score. In some embodiments, the answer relevancy score may be represented as a number within a range. For example, the answer relevancy score may be represented as a number between 0 and 100, with a higher score meaning the response 208 is more likely to have answered the query 204.

In some embodiments, the analysis of the relevancy between the context 206 and the response 208 may represent faithfulness and/or summarization. In some embodiments, the faithfulness and/or summarization may be analyzed based on faithfulness and/or summarization metrics configured to analyze whether the response 208 is free from false statements based on the context 206.

In instances in which the generated response 208 is irrelevant to the context 206, the likelihood of a hallucination 214 may increase. The metrics may not account for whether the response 208 is relevant to the query 204, as the query 204 is not analyzed. The analysis may simply address the relevance of the response 208 based on the context 206. As such, a low faithfulness or summarization may imply a hallucination 214, but a hallucination 214 may not necessarily imply low faithfulness and/or summarization.

In some embodiments, faithfulness in evaluating the context 206 and the response 208 may involve determining whether the response 208 is free from false statements based on the context 206. First, the individual claims made in the response 208 may be identified. Each claim may then be verified with respect to the context 206. In some embodiments, such operations may be performed using separate or specific models. For example, the analysis module may include a statement generation model, and/or a verification model. This process results in a faithfulness score, scored between 0 and 100, with higher scores indicating the response 208 is more factually consistent with the context 206.

In some embodiments, summarization in evaluating the context 206 and the response 208 may involve determining whether the response 208 is free from false statements based on the context 206. The context 206 and the response 208 may be encoded and compared using a fine-tuned model, determining whether the contents of the response 208 are true to the context 206. Such process may result in a summarization score, scored between 0 and 100, with higher scores indicating the text is more factually consistent.

In some embodiments, the analysis module 210 may be configured to determine source identifications 212. In some embodiments, the source identifications 212 may represent the relationship between the response 208 and the context 206. For example, the source identifications 212 may associate parts of the response 208 with corresponding portions of the context 206. In some embodiments, the source identifications 212 may be determined following the analysis based on the summarization and/or the faithfulness metrics. For example, the faithfulness and the summarization analysis may analyze the factual consistency of the response 208 with respect to the context 206. The source identifications 212 may then highlight and/or identify where in the context 206 the factual consistency of the response 208 was determined. The source identifications 212 may provide additional verification of the consistency between the response 208 and the context 206.

In some embodiments, the safety module 218 may obtain the hallucinations 214 and the source identifications 212. In some embodiments, the hallucinations 214 may be annotated with the sources or lack of sources leading to the hallucinations 214 as determined using the analysis module 210. In some embodiments, the source identifications 212 may include the response 208, annotated with sources from the context 206 that correspond to different parts of the response 208. In these and other embodiments, the safety module 218 may be configured to generate a safe response 220 based at least on the source identifications 212 and the hallucinations 214. The safe response 220 may be an improved version of the response 208 with respect to the hallucinations 214. For example, the safety module 218 may revise and/or modify the response 208 to reduce and/or eliminate the hallucinations 214 present in the response 208. For example, the safety module 218 may eliminate parts of the response 208 that lack sufficient support in the context 206. Such parts may be replaced with corresponding information that has support in the context 206.

In some embodiments, the modifications and/or revisions made by the safety module 218 may be provided to the Gen AI model 202. For example, the safe response 220 may be provided back to the Gen AI model 202. In these and other embodiments, the Gen AI model 202 may be trained using the safe response 220 to reduce the hallucinations 214.

In some embodiments, the analysis module 210 may be configured to determine a safety score 216 based at least on one or more of the determined scores (e.g., the context relevancy score, the answer relevancy score, the faithfulness score, and/or the summarization score). In some embodiments, the safety score 216 may include a single score representing the determined scores. For example, the safety score 216 may be a total or average of the one or more determined scores. Additionally or alternatively, the safety score 216 may include independent scores. In some embodiments, the reporting module 222 may be configured to generate a report 224 based at least on the safety scores 216. For example, the reporting module 222 may present the safety scores 216 in a user-friendly format. For example, the reporting module 222 may generate the report 224 on a user interface. In some embodiments, the report 224 may include the safety scores 216 for a plurality of Gen AI models. For example, the report 224 may be a comprehensive and/or comparative report across the plurality of Gen AI models.

Modifications, additions, or omissions may be made to the system 200 without departing from the scope of the present disclosure. For example, in some embodiments, the system 200 may include any number of other components that may not be explicitly illustrated or described. Further, depending on certain implementations, the system 200 may not include one or more of the components illustrated and described.

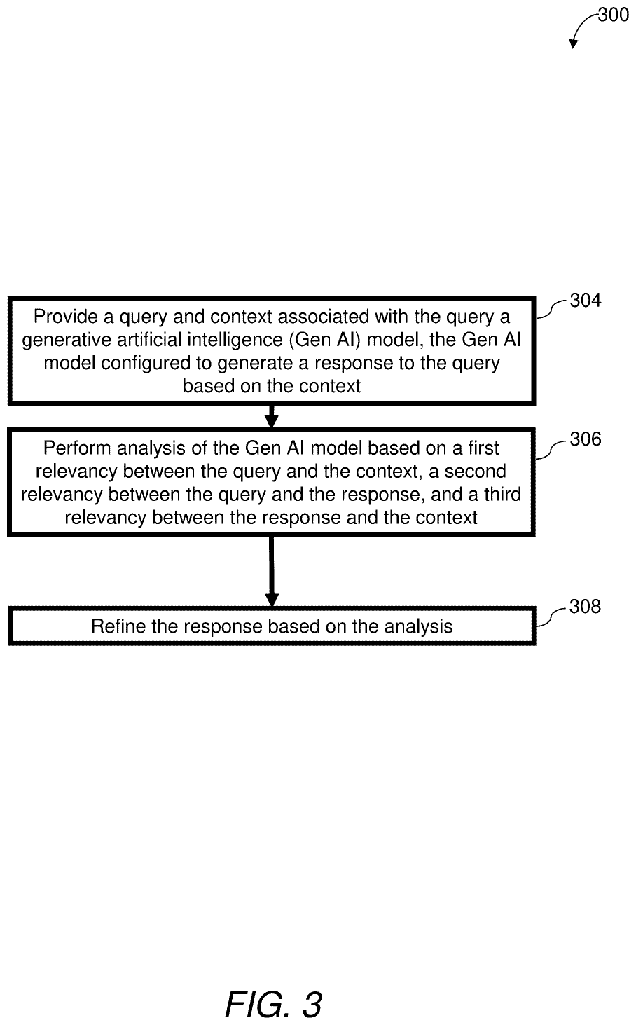

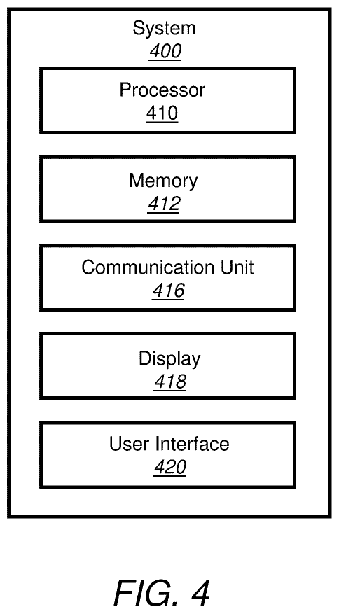

FIG. 3 is a flow chart of an example method 300 of the safety optimization process, arranged in accordance with at least one embodiment of the present disclosure. One or more operations of the method 300 may be implemented by any suitable systems such as the optimizer system 102 of FIG. 1, the system 200 of FIG. 2, and/or the computing system 400 of FIG. 4. Although illustrated as discrete steps, various steps of the method 300 may be divided into additional steps, combined into fewer steps, or eliminated, depending on the desired implementation. Additionally, the order of performance of the different steps may vary depending on the desired implementation.

In some embodiments, the method 300 may begin at block 304. At block 304, a query and context associated with the query may be provided to the Gen AI model. In some embodiments, the query may include questions, prompts, and/or instructions that may cause the Gen AI model to perform one or more operations. For example, the Gen AI model may be configured to generate a response to the query based on the context.

At block 306, an analysis of the Gen AI model may be performed based on a first relevancy between the query and the context, a second relevancy between the query and the response, and a third relevancy between the response and the context. In some embodiments, the first relevancy may be analyzed based on a context relevancy metric. In some embodiments, the second relevancy may be analyzed based on an answer relevancy metric. In some embodiments, the third relevancy may be analyzed based on one or more of a faithfulness metric or a summarization metric. In some embodiments, the analysis based on different metrics (e.g., the context relevancy metric, the answer relevancy metric, the faithfulness metric, and/or the summarization metric) may be described in further detail with respect to FIG. 2 of the present disclosure.

In some embodiments, the first relevancy, the second relevancy, and the third relevancy may be represented using a first score, a second score, and a third score, respectively. In some embodiments, the first score, the second score, and the third score may numerically represent the first relevancy, the second relevancy, and the third relevancy as a number within a range. For example, the first score, the second score, and the third score may be numbers between 0 and 100.

In some embodiments, the analysis may include detecting hallucinations in the response. In these and other embodiments, the hallucinations may refer to instances in which the Gen AI model generates information in the response that is factually incorrect, nonsensical, and/or fabricated but presented in a manner that appears plausible and/or convincing. In some embodiments, the hallucinations may be intrinsic and/or extrinsic. Intrinsic hallucinations may include the hallucinations that occur when the Gen AI model generates information that is internally inconsistent or illogical within the context of the response. Extrinsic hallucinations occur when the Gen AI model generates information that appears factual but is not verifiable.

In some embodiments, causes of the hallucinations may be determined based on the first relevancy, the second relevancy, and the third relevancy. For example, the first relevancy, the second relevancy, and the third relevancy may be used to determine which of the context, the query, and/or the response caused the hallucinations.

In some embodiments, the analysis may further include personal identifiable information (PII) detection. It is generally not recommended that PII is given to an LLM for use-cases where PII is unwanted in the response. However, even when no intentional PII is given to a Gen AI model, there are still a handful of cases where a PII detection may be of importance in Gen AI safety. In some embodiments, cases of accidental PII may include one or more of: LLMs (e.g., Gen AI models) leaking PII in their training data; PII being provided incorrectly to the LLMS (e.g., human error); LLMs outputting synthetic PII, which may seem real to a user, reducing trust in the privacy of the service; accidental PII input via the RAG pipeline. In these and other embodiments, the PII detection may aid in reduction of PII.

In some embodiments, the PII detection may be performed using a plurality of trusted PII detection models. Each detection model of the PII detection models may be trained to recognize a particular type of PII or an array of different types of PII. In these and other embodiments, using the plurality of PII detection models together may allow detection of PII across different types of PII. In some embodiments, the PII detection may include pattern recognition to identify known types of PII. This deterministic approach may help that all PII of a specified form is detected, making it repeatable, reproducible, and reliable. In some embodiments, the PII detection may be performed during data ingestion. For example, in the process of gathering and processing data that will be used to train, fine-tune, and/or evaluate the Gen AI model, the PII may be detected, such that the PII is not brought into the system.

Additionally or alternatively, a user may provide a blocklist including types of PII. For example, the user may specifically provide a list of types of PIIs to be detected and/or removed. Such list may help detect the explicitly listed PII, which may add flexibility for specific use-cases. In some embodiments, there may be specific text that resembles PII but is not wished to be blocked, such as customer support phone numbers or websites. To allow such specific PII to be used, the user may provide an allowlist, which lists such category of text.

At block 308, the response may be refined based on the analysis. For example, the response may be revised such that the hallucinations in the response are removed. For example, a safe response may be generated based on the response and the analysis of the response. In some embodiments, the safe response may correspond to the safe response 220 of FIG. 2. In some embodiments, the refinement process may be performed automatically. For example, an AI model may be used to refine the response based on the analysis. Additionally or alternatively, the refinement process may be performed manually by an operator. For example, an end user or an AI developer may refine the response based on the analysis.

Modifications, additions, or omissions may be made to the method 300 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 300 may further include assigning a safety score to the response based on one or more of the first relevancy, the second relevancy, or the third relevancy. The safety score may represent how well the response is performing with respect to hallucinations. In some embodiments, the safety score may include one or more of the first score, the second score, or the third score. In some embodiments, the safety score may be a comprehensive score representing all of the first score, the second score, and the third score.

In some embodiments, the safety score may be determined based on one or more safety policies. In these and other embodiments, the one or more safety policies may include global, national, and/or industrial policies related to the safety of AI models. Additionally or alternatively, the safety policies may include user-specific safety policies. The one or more safety policies may provide standards on which to evaluate the response and/or the Gen AI model. In these and other embodiments, the one or more safety policies may define which of the safety metrics are relevant. Additionally, the one or more safety policies may define ranges which the safety metrics apply.

In some embodiments, a report including at least the safety score may be generated. In some embodiments, the report may be provided to the user. For example, the report may be generated on a user interface. In some embodiments, the user may interact with the report via the user interface. For example, the user may modify views and/or focuses of the report.

FIG. 4 is a block diagram illustrating an example system 400 that may be used for optical signal amplification, according to at least one embodiment of the present disclosure. The system 400 may include a processor 410, memory 412, a communication unit 416, a display 418, and a user interface unit 420, which all may be communicatively coupled. In some embodiments, the system 400 may be used to perform one or more of the methods described in this disclosure.

For example, the system 400 may be used to assist in the performance of the method described in FIG. 4. For example, the system 400 may be used to determine a number of optical fiber amplifiers to cascade, a number of filters to cascade, and the length of the optical fiber in each of the amplifiers.

Generally, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of networks or physical locations that are configured to perform individually or collectively any number of operations described herein. In some embodiments, the processor 410 may interpret and/or execute program instructions and/or process data stored in the memory 412. In some embodiments, the processor 410 may execute the program instructions stored in the memory 412.

For example, in some embodiments, the processor 410 may execute program instructions stored in the memory 412 that are related to task execution such that the system 400 may perform or direct the performance of the operations associated therewith as directed by the instructions. In these and other embodiments, the instructions may be used to perform one or more blocks of method 300 of FIG. 3.

The memory 412 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 410.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 410 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 400 F.3d 1346 (Fed. Cir. 2007). Combinations of the above may also be included within the scope of computer-readable media.

The communication unit 416 may include any component, device, system, or combination thereof that is configured to transmit or receive information over a network. In some embodiments, the communication unit 416 may communicate with other devices at other locations, the same location, or even other components within the same system. For example, the communication unit 416 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 416 may permit data to be exchanged with a network and/or any other devices or systems described in the present disclosure.

The display 418 may be configured as one or more displays, like an LCD, LED, Braille terminal, or other type of display. The display 418 may be configured to present video, text captions, user interfaces, and other data as directed by the processor 410.

The user interface unit 420 may include any device to allow a user to interface with the system 400. For example, the user interface unit 420 may include a mouse, a track pad, a keyboard, buttons, camera, and/or a touchscreen, among other devices. The user interface unit 420 may receive input from a user and provide the input to the processor 410. In some embodiments, the user interface unit 420 and the display 418 may be combined.

Modifications, additions, or omissions may be made to the system 400 without departing from the scope of the present disclosure. For example, in some embodiments, the system 400 may include any number of other components that may not be explicitly illustrated or described. Further, depending on certain implementations, the system 400 may not include one or more of the components illustrated and described.

As indicated above, the embodiments described herein may include the use of a special purpose or general-purpose computer (e.g., the processor 410 of FIG. 4) including various computer hardware or software modules, as discussed in greater detail below. Further, as indicated above, embodiments described herein may be implemented using computer-readable media (e.g., the memory 412 of FIG. 4) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
providing a query and context associated with the query to a generative artificial intelligence (Gen AI) model, the Gen AI model trained to generate a response to the query based on the context;
performing analysis of the Gen AI model based on a first relevancy between the query and the context, a second relevancy between the query and the response, and a third relevancy between the response and the context; and
refining the response based on the analysis.

2. The method of claim 1, wherein performing the analysis comprises:
detecting hallucinations in the response; and
identifying causes of the hallucinations based on the first relevancy, the second relevancy, and the third relevancy.

3. The method of claim 2, wherein the hallucinations include are intrinsic or extrinsic.

4. The method of claim 2, wherein the first relevancy is analyzed based on context relevancy metric.

5. The method of claim 2, wherein the second relevancy is analyzed based on answer relevancy metric.

6. The method of claim 2, wherein the third relevancy is analyzed based on one or more of faithfulness metric or summarization metric.

7. The method of claim 1, wherein the first relevancy, the second relevancy, and the third relevancy are represented using a first score, a second score, and a third score, respectively.

8. The method of claim 1, further comprising:
obtaining one or more safety policies;
assigning a safety score to the response based on one or more safety policies; and
generating a report including at least the safety score.

9. The method of claim 1, further comprising:
assigning a safety score to the response based on the first relevancy, the second relevancy, and the third relevancy; and
generating a report including at least the safety score.

10. The method of claim 1, wherein the analysis includes personal identifiable information (PII) detection.

11. The method of claim 10, wherein the PII detection is performed using a plurality of PII detection models.

12. A system comprising:
one or more processors; and
one or more non-transitory computer-readable storage media configured to store instructions that, in response to being executed, cause a system to perform operations, the operations comprising:
providing a query and context associated with the query to a generative artificial intelligence (Gen AI) model, the Gen AI model trained to generate a response to the query based on the context;
performing analysis of the Gen AI model based on a first relevancy between the query and the context, a second relevancy between the query and the response, and a third relevancy between the response and the context; and
refining the response based on the analysis.

13. The system of claim 12, wherein performing the analysis comprises:
detecting hallucinations in the response; and
identifying causes of the hallucinations based on the first relevancy, the second relevancy, and the third relevancy.

14. The system of claim 13, wherein the hallucinations include are intrinsic or extrinsic.

15. The system of claim 13, wherein the first relevancy is analyzed based on context relevancy metric.

16. The system of claim 13, wherein the second relevancy is analyzed based on answer relevancy metric.

17. The system of claim 13, wherein the third relevancy is analyzed based on one or more of faithfulness metric or summarization metric.

18. The system of claim 12, wherein the first relevancy, the second relevancy, and the third relevancy are represented using a first score, a second score, and a third score, respectively.

19. One or more non-transitory computer-readable media storing instructions that, when executed by one or more processors, cause a system to perform operations, the operations comprising:
providing a query and context associated with the query to a generative artificial intelligence (Gen AI) model, the Gen AI model trained to generate a response to the query based on the context;
performing analysis of the Gen AI model based on a first relevancy between the query and the context, a second relevancy between the query and the response, and a third relevancy between the response and the context; and
refining the response based on the analysis.

20. The one or more non-transitory computer-readable media of claim 19, wherein the analysis includes personal identifiable information (PII) detection.
